(19) United States
(12) Patent Application Publication
(10) Pub. No.: US 2022/0113416 A1
(43) Pub. Date: Apr. 14, 2022

(54) Range Finder and Range Finding Method

(71) Applicant: Nippon Telegraph and Telephone Corporation, Tokyo (JP)

(72) Inventors: Masahiro Ueno, Tokyo (JP); Yuichi Akage, Tokyo (JP); Soichi Oka, Tokyo (JP)

(21) Appl. No.: 17/439,118

(22) PCT Filed: Mar. 4, 2020
(86) PCT No.: PCT/JP2020/009103

§ 371 Date: Sep. 14, 2021

(30) Foreign Application Priority Data
Mar. 18, 2019 (JP) 2019-049515

(51) Int. Cl. G01S 17/36; G01S 7/481; G01S 17/894

(52) U.S. Cl. CPC G01S 17/36; G01S 17/894; G01S 7/4817

(57) ABSTRACT

A distance measurement apparatus includes a first acquisition unit that acquires a time t_{r, i} of each peak p_{r, i} included in a second reference signal obtained by photoelectrically converting light periodically intensity-modulated and output from a light source, a second acquisition unit that acquires a peak p_{s, i} present in a range of ±_{Tsource}/2 based on the time t_{r, i} from a second detection signal obtained by photoelectrically converting reflected light of light output from the light source and reflected by an object, and a distance calculation unit that calculates a distance to an object based on a cross-correlation between a first signal obtained by processing the second reference signal in a state where a peak of a window function matches the peak p_{s, i} and a second signal obtained by processing the second detection signal in a state where a peak of a window function matches the peak p_{s, i}.

This patent application is a national phase filing under section 371 of PCT/JP2020/009103, filed Mar. 4, 2020, which claims the priority of Japanese patent application no. 2019-049515, filed Mar. 18, 2019, each of which is incorporated herein by reference in its entirety.

### TECHNICAL FIELD

The present invention relates to a distance measurement apparatus and a distance measurement method, and more particularly to a distance measurement technique using a time-of-flight method.

### BACKGROUND

A TOF (Time of Flight) method has heretofore been known as a technique for measuring a distance to an object. For example, Non-Patent Literature 1 discloses, as distance measurement processing using the TOF method, a technique for transmitting an ultrasonic wave, measuring a flight time from a time when the ultrasonic wave is reflected to a time when the ultrasonic wave is returned, and multiplying the flight time by the sonic speed to thereby derive a distance to an object.

In the distance measurement technique using the TOF method as described in Non-Patent Literature 1, a time difference between two signals, i.e., a reference signal based on which a time is measured and a detection signal obtained by converting an ultrasonic wave, which is reflected by an object and is then returned, into an electrical signal, is obtained using a cross-correlation function. Accordingly, a time of each peak in a cross-correlation function corresponds to the time difference between two signals.

When the time difference between the two signals, i.e., the reference signal and the detection signal, is represented by Δt, a distance measurement value L of a distance to an object to be measured is expressed as vΔt/2, where v represents the sonic speed. In Non-Patent Literature 1, an ultrasonic wave is used. However, the same effect can be obtained by replacing an ultrasonic wave with light. In this case, the distance measurement value L is expressed as cΔt/2, where c represents the light speed.

Non-Patent Literature 2 discloses a technique for measuring a distance using the TOF method while primarily scanning light with a light deflector. In this case, the angle of light output from the light deflector changes temporally. Accordingly, in order to measure a distance at a certain angle, there is a need to retrieve a signal with a short duration from each of the two signals, i.e., the reference signal and the detection signal of reflected light, which is reflected by an object and is then returned, based on the time corresponding to the angle. In distance measurement, a time difference between the reference signal and the detection signal at the angle or time is obtained based on a cross-correlation between these two retrieved signals, thereby obtaining a distance to an object based on the time difference.

Thus, when a signal with a short duration is retrieved from time-series signals, such as the reference signal and the detection signal, a window function can be used. In the technique of the related art, a time window designed with the center of a duration in which a signal is retrieved as a peak is used. Accordingly, peak positions corresponding to the reference signal and the detection signal before the window function is applied to the signal may be different from those after the window function is applied to the signal.

FIG. 7 illustrates an example of using a window function according to the related art. Solid lines represent a reference signal r and a detection signal s, respectively. A broken line represents a duration. A dashed-dotted line represents a window function w. Dotted lines represent a reference signal rw and a detection signal sw, respectively, after the window function is applied. Peaks of the reference signals r and rw and peak times corresponding to the detection signals s and sw before the window function is applied are different from those after the window function is applied. As a result, the time differences Δt and Δtw between both peaks are different. As a result, the time difference Δt between the reference signal r and the detection signal s cannot be accurately measured, which makes it difficult to accurately measure a distance.

### CITATION LIST

### Non-Patent Literature

Non-Patent Literature 1: Hirata Shinnosuke, Kurosawa Minoru, Katagiri Takashi, “Experiments of ultrasonic distance measurement using cross-correlation by single-bit signal processing”, the Institute of Electronics, Information and Communication Engineers, Technology Report US2007-117, pp. 49-54, February 2008.

Non-Patent Literature 2: Kohira Tohru, Yagi Syogo, Fujiura Kazuo, Mori Jiro, Watanabe Takeshi, “Swept position measurement system using a wavelength sweeping technique”, Optical Technology Contact, Vol. 55, No. 8, pp. 18-27, Issued on Aug. 20, 2017.

### SUMMARY

### Technical Problem

Embodiments of the present invention have been made to solve the above-described problem, and an embodiment of the present invention is to provide a distance measurement apparatus and a distance measurement method which are capable of measuring a distance to an object with high accuracy even when a window function is used.

### Means for Solving the Problem

To solve the above-described problem, a distance measurement apparatus according to embodiments of the present invention includes: a first acquisition unit that detects a first peak as a peak included in a first signal obtained by photoelectrically converting light periodically intensity-modulated and output from a light source, and acquires a time of each first peak; a second acquisition unit that acquires, from a second signal, a second peak as a peak present in a time range of one cycle of intensity modulation of light from the light source based on the time of the first peak, the second peak being obtained by photoelectrically converting reflected light, the reflected light being the light output from the light source and reflected by an object to be measured; and a distance calculation unit that calculates a distance to the object based on a cross-correlation between a third signal and a fourth signal, the third signal being obtained by processing the first signal with a first window function in a state where a peak of the first window function having the peak matches the first peak, the fourth signal being obtained by processing the second signal with a second window function in a state where a peak of the second window function having the peak matches the second peak.

The distance measurement apparatus according to embodiments of the present invention may further include an optical system including: an optical splitter that splits light from the light source into two beams; a first photodetector that detects one of the beams of the light output from the optical splitter; a light deflector that deflects the other of the beams of the light output from the optical splitter and outputs the deflected beam to the object; and a second photodetector that detects reflected light, the reflected light being light output from the light deflector and reflected by the object. The first photodetector may output the first signal obtained by photoelectrically converting the detected light, and the second photodetector may output the second signal obtained by photoelectrically converting the detected reflected light.

The distance measurement apparatus according to embodiments of the present invention may further include a time-angle transformation unit that transforms time information corresponding to the time of the first peak calculated by the distance calculation unit into information about a deflection angle set by the light deflector, and outputs a deflection angle-distance signal indicating the deflection angle associated with the distance.

The distance measurement apparatus according to embodiments of the present invention may further include an interpolation unit that interpolates the distance to the object corresponding to the time of each first peak of the first signal calculated by the distance calculation unit.

Further, in the distance measurement apparatus according to embodiments of the present invention, the distance calculation unit may include a time difference calculation unit that calculates, using the cross-correlation, a time difference indicating a time delay of the second signal with respect to the first signal at the time of the first peak, and the distance calculation unit may calculate the distance to the object corresponding to the time of each first peak of the first signal based on the calculated time difference.

Further, in the distance measurement apparatus according to embodiments of the present invention, the first window function and the second window function may have the same shape.

Further, in the distance measurement apparatus according to embodiments of the present invention, the first window function and the second window function are any one of a Gaussian window, a Hann window, a Hamming window, a Blackman window, and a generalized Hamming window.

To solve the above-described problem, a distance measurement method according to embodiments of the present invention includes: a first step of detecting a first peak as a peak included in a first signal obtained by photoelectrically converting light periodically intensity-modulated and output from a light source, and acquires a time of each first peak; a second step of acquiring, from a second signal, a second peak as a peak present in a time range of one cycle of intensity modulation of light from the light source based on the time of the first peak, the second peak being obtained by photoelectrically converting reflected light, the reflected light being the light output from the light source and reflected by an object to be measured; and a third step of calculating a distance to the object based on a cross-correlation between a third signal and a fourth signal, the third signal being obtained by processing the first signal with a first window function in a state where a peak of the first window function having the peak matches the first peak, and the fourth signal being obtained by processing the second signal with a second window function in a state where a peak of the second window function having the peak matches the second peak.

### Effects of Embodiments of the Invention

According to embodiments of the present invention, a cross-correlation between a third signal and a fourth signal is used. The third signal is obtained by processing a first signal with a first window function in a state where a peak of the first window function matches a first peak included in the first signal obtained by photoelectrically converting light periodically intensity-modulated and output from a light source. The fourth signal is obtained by processing the second signal with a second window function in a state where a peak of the second window function matches a second peak of a second signal obtained by photoelectrically converting reflected light reflected by an object to be measured. Accordingly, it is possible to measure a distance to an object with high accuracy even when a window function is used.

### BRIEF DESCRIPTION OF THE DRAWINGS

FIG. 1 is a block diagram illustrating a configuration of a distance measurement apparatus according to an embodiment of the present invention.

FIG. 2 is a block diagram illustrating a configuration of a distance measurement unit according to an embodiment of the present invention.

FIG. 3 is a graph illustrating distance measurement processing according to an embodiment of the present invention.

FIG. 4 is a block diagram illustrating an example of a configuration of a computer for implementing a signal processing device according to an embodiment of the present invention.

FIG. 5 is a flowchart illustrating a distance measurement method according to an embodiment of the present invention.

FIG. 6 is a flowchart illustrating distance measurement processing according to an embodiment of the present invention.

FIG. 7 is a graph illustrating distance measurement processing according to the related art.

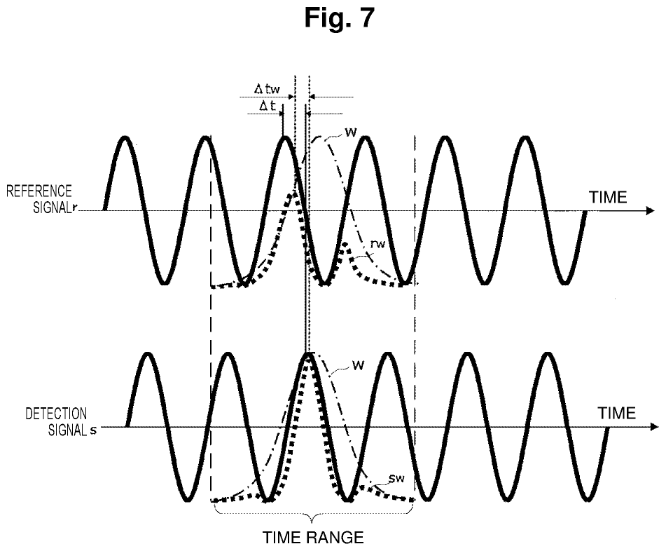

### DETAILED DESCRIPTION OF ILLUSTRATIVE EMBODIMENTS

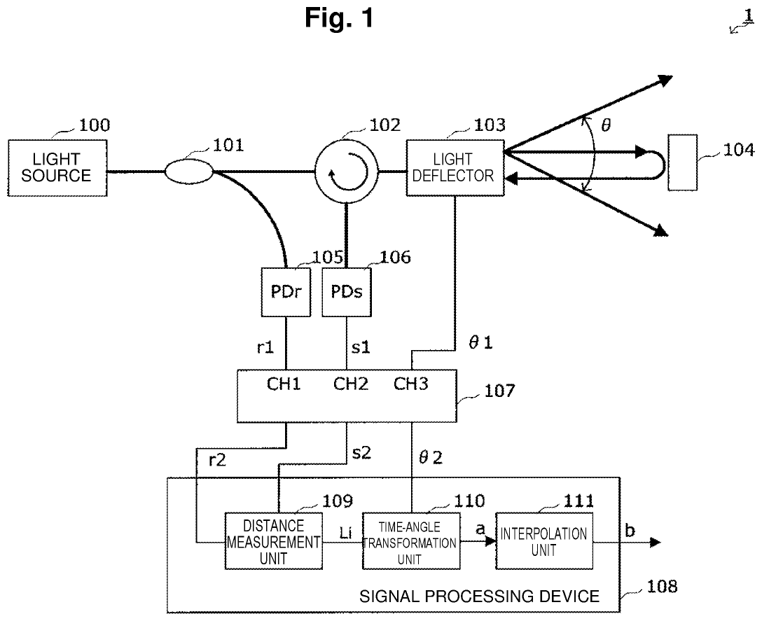

Preferred embodiments of the present invention will be described below with reference to FIGS. 1 to 6.

FIG. 1 is a block diagram illustrating a configuration of a distance measurement apparatus 1 according to an embodiment of the present invention. As illustrated in FIG. 1, the distance measurement apparatus 1 according to the present embodiment measures a distance from the distance measurement apparatus 1 to an object 104 by a TOF method. More specifically, the distance measurement apparatus 1 measures a difference between the following two flight times to obtain the difference from the distance measurement apparatus 1 to the object 104. The first flight time is a flight time from a time when light is output from a coupler 101 to a time when reflected light that is reflected on the surface of the object 104 serving as a distance measurement target is received by a photodetector PDs 106. The second flight time is a flight time from a time when light is output from the coupler 101 to a time when the light is received by a photodetector PDr 105.

As illustrated in FIG. 1, the distance measurement apparatus 1 includes a light source 100, the coupler 101, a circulator 102, a light deflector 103, the photodetector (hereinafter referred to as “PDr”) 105, the photodetector (hereinafter referred to as “PDs”) 106, an analog-to-digital converter (ADC) 107, and a signal processing device 108. The coupler 101 is used as an optical splitter that splits light.

The light source 100, the coupler 101, the circulator 102, the light deflector 103, the PDr (first photodetector) 105, and the PDs (second photodetector) 106 constitute an optical system included in the distance measurement apparatus 1.

The light source 100 outputs periodically intensity-modulated light to the object 104. Specifically, the light source 100 generates periodically intensity-modulated light such as a sine wave or a pulse signal. The light output from the light source 100 enters the light deflector 103 to be described below.

The coupler 101 divides the light output from the light source 100 into beams that pass through a reference optical path and an object optical path, respectively. One of the beams of light divided by the coupler 101 is input to the PDr 105 on the reference optical path, and the other of the beams is irradiated on the object 104 through the circulator 102 and the light deflector 103 on the object optical path.

The PDr 105 detects the light output from the light source 100, and converts the light into a first reference signal (first signal) r1 which is an analog signal. The obtained first reference signal r1 is input to a channel 1 (CH1) of the ADC 107.

The circulator 102 divides light beams traveling in opposite directions on an optical path. More specifically, the circulator 102 divides light into a light beam that is output from the coupler 101 and irradiated on the object 104 and a light beam that is reflected by the object 104 and is returned.

The light deflector 103 deflects an optical axis of light incident from the light source 100 and outputs the deflected light. More specifically, the light deflector 103 deflects the light, which is output from the light source 100 and incident through the coupler 101 and the circulator 102, and outputs the deflected light. To output light by changing an optical axis of incident light by the light deflector 103 is hereinafter referred to as “deflected light”.

The light deflector 103 deflects light from the light source 100 within a range of a preset deflection angle. As the light deflector 103, for example, a Galvanometer mirror, a polygon mirror, or a deflector using KTN (potassium tantalate niobate) crystal can be used. The deflection angle set by the light deflector 103 can be set so as to fall within a desired deflection angle range by mirror design or control using a driving device which is not illustrated and is included in the light deflector 103.

The light deflector 103 deflects light from the light source 100 and outputs the deflected light, thereby scanning the object 104 and a space around the object (sweeping in a space, or deflecting) and causing the light to be reflected on the surface of the object 104 as a distance measurement target. Every time the light deflector 103 scans the light from the light source 100 with output light within the set deflection angle range, the reflected light from the object 104 is detected by the PDs 106 to be described below.

The PDs 106 detects the reflected light from the object 104 through the circulator 102, and converts the detected light into a first detection signal (second signal) s1 which is an analog signal. The obtained first detection signal s1 is input to a channel 2 (CH2) of the ADC 107.

The ADC 107 includes three channels, converts an input analog signal into a digital signal, and outputs the digital signal. The digital signal that is obtained through conversion for each channel by the ADC 107 and output from the ADC 107 is input to the signal processing device 108. The first reference signal r1, which is an analog signal input to the channel CH1 is converted into a digital second reference signal (first signal) r2 and the second reference signal r2 is input to a distance measurement unit 109 to be described below. The first detection signal s1 input to the channel CH2 is also converted into a digital second detection signal (second signal) s2 and the converted second detection signal s2 is input to the distance measurement unit 109. A first angle signal θ1, which is an analog signal indicating a deflection angle of the light deflector 103, is input to a channel CH3, and is converted into a digital second angle signal θ2 and input to a time-angle transformation unit 110 to be described below.

As illustrated in FIG. 1, the signal processing device 108 calculates a distance from the distance measurement apparatus 1 to the object 104 for each deflection angle using the digital signal output from the ADC 107 as an input signal. Specifically, the distance from the coupler 101 to the object 104 can be obtained. More specifically, the distance from the coupler 101 to the object 104 is ½ of the distance obtained by subtracting the length of the optical path of the coupler 101−the PDr 105 from the length of the optical path of the coupler 101−the circulator 102−the light deflector 103−the object 104−the light deflector 103−the circulator 102−the PDs 106.

The signal processing device 108 includes the distance measurement unit 109, the time-angle transformation unit 110, and an interpolation unit 111.

The distance measurement unit 109 outputs distance data corresponding to the time based on the second reference signal r2 and the second detection signal s2 output from the ADC 107. The distance measurement unit 109 acquires a time of a peak (first peak) of the second reference signal r2 and measures a distance from the distance measurement apparatus 1 to the object 104 at the time. In the case of measuring the distance within the range of the angle at which light is primarily deflected by the light deflector 103, the data measurement can be performed for a smaller angle. In the present embodiment, the distance measurement is performed for each peak of the second reference signal r2. Further, if a distance between peaks is required, the interpolation unit 111 to be described below interpolates the distance between peaks by using the distance at the peak position, thereby obtaining a more detailed distance from the distance measurement apparatus 1 to the object 104.

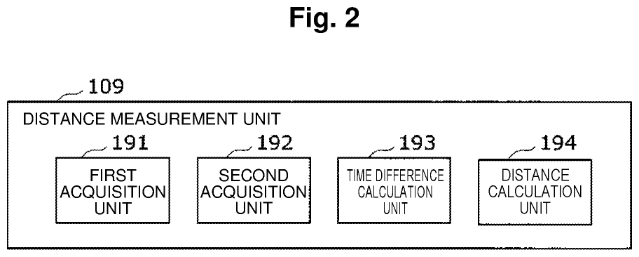

As illustrated in FIG. 2, the distance measurement unit 109 includes a first acquisition unit 191, a second acquisition unit 192, a time difference calculation unit 193, and a distance calculation unit 194.

The first acquisition unit 191 detects all peaks included in the second reference signal r2, and acquires the time corresponding to the peaks. As described above, the light output from the light source 100 is light that is periodically intensity-modulated. The cycle of intensity modulation in the light source 100 is represented by T_{source}, and the frequency is represented by f_{source} (=1/T_{source}).

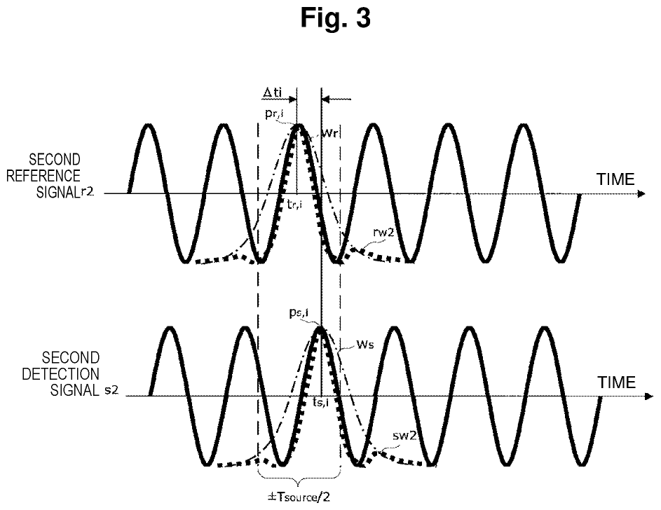

For example, as illustrated in an upper portion of FIG. 3, the first acquisition unit 191 detects all peaks p_{r, i} (i=0, 1, . . . ) included in the second reference signal r2. In FIG. 3, the second reference signal r2 and the second detection signal s2 are time-series signals. The horizontal axis represents time, and the vertical axis represents a signal intensity.

The second acquisition unit 192 acquires a peak (second peak) of the second detection signal s2 that is present within the range of one cycle of intensity modulation of the light source 100 based on the time of each peak of the second reference signal r2. For example, as illustrated in FIG. 3, the second acquisition unit 192 detects a peak p_{s, i} of the second detection signal s2 within a range of ±T_{source}/2 based on a time t_{r, i} of an i-th peak p_{r, i} of the second reference signal r2. The time of the obtained peak p_{s, i} is represented by t_{s, i}.

The time difference calculation unit 193 calculates a time delay of the second detection signal s2 with respect to the second reference signal r2 at the peak time t_{r, i} of the second reference signal r2. Specifically, as illustrated in FIG. 3, the time difference calculation unit 193 calculates a time difference Δtᵢ (=t_{s, i}−t_{r, i}) from the time t_{s, i} of the peak p_{s, i} of the second detection signal s2 based on the time t_{r, i} of the peak p_{r, i} of the second reference signal r2.

More specifically, in the calculation of the time difference Δtᵢ, the time difference calculation unit 193 processes the second reference signal r2 and the second detection signal s2 with a window function w(t), and clips a part of each of the signals. Specifically, in the measurement of the distance to the object 104 at a desired deflection angle, the time difference calculation unit 193 clips a part of each of the second reference signal r2 and the second detection signal s2 with the window function w(t) based on the time corresponding to the desired deflection angle.

The time difference calculation unit 193 calculates a cross-correlation function representing a temporal relationship between the clipped second reference signal r2 and the clipped second detection signal s2, and sets the time when a maximum value of the cross-correlation function is obtained as Δtᵢ. The maximum value of the cross-correlation function generally corresponds to a peak.

A cross-correlation function R(t) can be obtained by the following Expression (1) using Fourier transform.

Expression (1)

R(t)=F⁻¹[S_{Sw}(ν)S_{Rw}*(ν)] (1) (1)

where F⁻¹[.] represents an inverse Fourier transform, S_{Sw}(.) represents the result of Fourier transform on the clipped second detection signal s2, S_{Rw}(.) represents the result of Fourier transform on the clipped second reference signal r2, v represents the frequency of each signal, and * represents a complex conjugate.

In the case of clipping a part of each of the second reference signal r2 and the second detection signal s2 when the above-described Expression (1) is used, the time difference calculation unit 193 performs processing using a window function in a state where the window function having a single peak matches a peak of each signal. For example, FIG. 3 illustrates an example of measuring the distance at a certain time t_{r, i} of the i-th peak p_{r, i} of the second reference signal r2.

Solid lines in FIG. 3 represent the second reference signal r2 and the second detection signal s2, respectively. A range indicated by a broken line vertical to the time axis represented by the horizontal axis indicates a time range in which peaks of the second detection signal s2 are searched. Dashed-dotted lines indicate window functions wr(t) and ws(t), respectively. Dotted lines respectively indicate a second reference signal rw2 (third signal) obtained after the window function wr(t) (first window function) is applied and a second detection signal sw2 (fourth signal) obtained after the window function ws(t) (second window function) is applied.

As for the second reference signal r2, as illustrated in the upper portion of FIG. 3, the time difference calculation unit 193 clips a signal corresponding to a time in the vicinity of the time t_{r, i} of the peak p_{r, i} by applying the window function wr(t) to the second reference signal r2 in a state where the window function wr(t) having a single peak matches the i-th peak p_{r, i}. As for the second detection signal s2, as illustrated in a lower portion of FIG. 3, the time difference calculation unit 193 causes the window function ws(t) having a single peak to match the peak p_{s, i} that is present in the searched time range. Further, the second detection signal s2 at a time in the vicinity of the time t_{s, i} of the peak p_{s, i} is clipped by applying the window function ws(t) to the second detection signal s2.

For example, based on the time t_{r, i} of the peak p_{r, i} acquired by the first acquisition unit 191, the peak of the window function wr(t) can match the peak p_{r, i} of the second reference signal r2. Further, based on the peak time t_{s, i} and the peak p_{s, i} of the second detection signal s2 acquired by the second acquisition unit 192, the peak of window function ws(t) can match the peak p_{s, i} of the second detection signal s2.

Thus, the time difference calculation unit 193 performs window processing in a state where the peak positions of the window functions wr(t) and ws(t) each having a peak match the peaks of the second reference signal r2 and the second detection signal s2, thereby clipping a part of each of the second reference signal r2 and the second detection signal s2. Thus, the peak times of the second reference signal r2 and the second detection signal s2 before the window functions wr(t) and ws(t) are applied match those after the window functions wr(t) and ws(t) are applied. Therefore, the time difference Δtᵢ can be output as the originally set time difference obtained before the window function w(t) is applied. Consequently, the distance to the object 104 can be accurately calculated.

The window function wr(t) used for the second reference signal r2 by time difference calculation unit 193 and the window function ws(t) used for the second detection signal s2 by the time difference calculation unit 193 may be window functions having the same shape. The window functions wr(t) and ws(t) each have a single peak and a shape in which an amplitude gradually decreases symmetrically with the peak. Specific examples of the window function w(t) include a Gaussian window, a Hann window, a Hamming window, a Blackman window, and a generalized Hamming window. In particular, as for window functions such as a Hann window and a Blackman window, values at both ends of a signal obtained after the window function is applied are zero and the first derivative coefficient is zero. By adopting such window functions with which values at both ends of a signal to which the window functions wr(t) and ws(t) are applied are prevented from being discontinuous, high-frequency components which may be generated due to the fact that values at both ends of the signal are discontinuous are prevented from being generated. Therefore, it is considered that window functions, such as a Hann window and a Blackman window, are particularly useful.

The distance calculation unit 194 calculates a distance Lᵢ to the object 104 corresponding to the time t_{r, i} for each peak p_{r, i} of the second reference signal r2. Specifically, the distance calculation unit 194 calculates the distance Lᵢ to the object 104 based on the time difference Δtᵢ calculated by the time difference calculation unit 193. The distance calculation unit 194 can calculate time-distance data Lᵢ as the distance associated with the time by using Lᵢ=cΔtᵢ/2.

The time-angle transformation unit 110 transforms the time-distance data Lᵢ calculated by the distance calculation unit 194 into distance data (deflection angle-distance data) a corresponding to the deflection angle by using the second angle signal θ2.

More specifically, the light deflector 103 outputs the first angle signal θ1 as a time-varying signal of a voltage corresponding to an angle. As described above, the first angle signal θ1 is input to the channel CH3 of the ADC 107, and is converted into the discretized digital second angle signal θ2. The intensity of the second angle signal θ2 corresponds to the deflection angle of light output from the light deflector 103. Accordingly, at the same time, the deflection angle-distance data a can be obtained by associating the intensity of the second angle signal θ2 with the distance of the time-distance data Lᵢ.

Therefore, for example, the time-angle transformation unit 110 preliminarily holds a correlation table illustrating a correspondence between the intensity of the second angle signal θ2 and the deflection angle, and functions (including an approximate function) representing a relationship between the intensity of the second angle signal θ2 and the deflection angle. Further, the time-angle transformation unit 110 reads out the preliminarily stored correspondence table, functions, and the like, and associates the intensity of the second angle signal θ2 with the deflection angle.

Thus, since the time-distance data Lᵢ is distance data for each peak time t_{r, i} of the second reference signal r2, the deflection angle-distance data a is also data indicating the deflection angle associated with the distance for each peak time t_{r, i} of the second reference signal r2.

The interpolation unit 111 outputs deflection angle-distance data b obtained by interpolating a peak p_{r, i} of the second reference signal r2 to the deflection angle-distance data a output by the time-angle transformation unit 110. The interpolation unit 111 interpolates the deflection angle-distance data a indicating the deflection angle associated with time-distance data L at the deflection angle (time) included in the space between peaks of the second reference signal r2. The interpolation unit 111 outputs data on a distance corresponding to a more detailed deflection angle (time) included in the space between peaks of the second reference signal r2 as interpolated deflection angle-distance data b. Thus, the provision of the interpolation unit 111 makes it possible to obtain data indicating a temporally (in terms of angle) closer distance.

### Hardware Configuration of Signal Processing Device

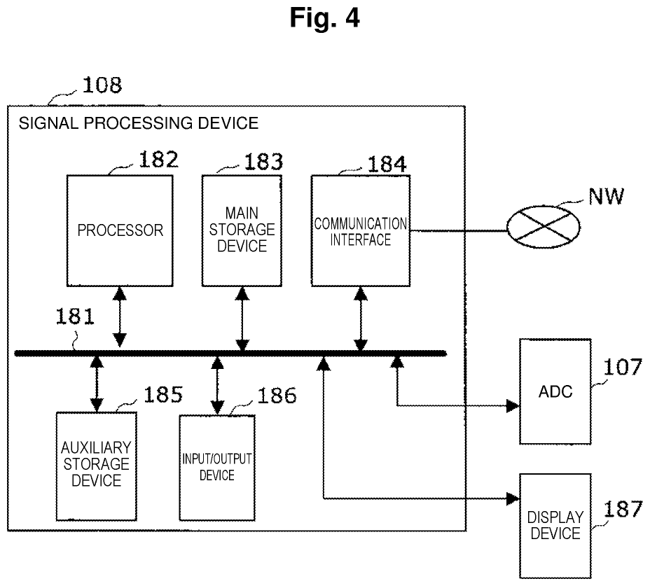

Next, an example of a hardware configuration of the signal processing device 108 including the above-described functions will be described with reference to FIG. 4.

As illustrated in FIG. 4, the signal processing device 108 can be implemented by, for example, a computer including a processor 182, a main storage device 183, a communication interface 184, an auxiliary storage device 185, and an input/output device 186, which are connected via a bus 181, and a program for controlling these hardware resources. The signal processing device 108 may be connected with, for example, a display device 187 via the bus 181, and may display the interpolated deflection angle-distance data b and the like on a display screen. Further, the ADC 107 and the optical system of the distance measurement apparatus 1 are connected via the bus 181 and the input/output device 186.

The main storage device 183 is implemented by, for example, a semiconductor memory such as an SRAM, a DRAM, and a ROM. The main storage device 183 preliminarily stores programs used for the processor 182 to perform various control operations and calculations. The processor 182 and the main storage device 183 implement the functions of the signal processing device 108 including the distance measurement unit 109, which includes the first acquisition unit 191, the second acquisition unit 192, the time difference calculation unit 193, and the distance calculation unit 194, the time-angle transformation unit 110, and the interpolation unit 111 illustrated in FIGS. 1 and 2. Further, the processor 182 and the main storage device 183 can perform settings and control operations for the optical system and the ADC 107.

The communication interface 184 is an interface circuit for communicating with various external electronic devices via a communication network NW. The signal processing device 108 may send, for example, the interpolated deflection angle-distance data b or the like to the outside via the communication interface 184.

As the communication interface 184, for example, an interface and an antenna which comply with wireless data communication standards, such as LTE, 3G, wireless LAN, or Bluetooth®, are used. Examples of the communication network NW include a Wide Area Network (WAN), a Local Area Network (LAN), the Internet, a dedicated line, a radio base station, and a provider.

The auxiliary storage device 185 is composed of a readable/writable storage medium and a driving device for reading and writing various information, such as programs and data, in the storage medium. As the auxiliary storage device 185, a semiconductor memory such as a hard disk and a flash memory can be used as a storage medium.

The auxiliary storage device 185 includes a program storage area for storing programs used for the signal processing device 108 to perform distance measurement processing, transformation processing, and interpolation processing. The auxiliary storage device 185 may further include, for example, a backup area for backing up the above-described data, programs, and the like.

The auxiliary storage device 185 stores correspondence tables and transformation curves used for the time-angle transformation unit 110 to perform transformation processing. Alternatively, the main storage device 183 may store correspondence tables and transformation curves used for the time-angle transformation unit 110 to perform transformation processing. In this case, at start-up of the apparatus, these correspondence tables and transformation curves may be read out from the auxiliary storage device 185 into the main storage device 183, or a memory storing the correspondence tables and transformation curves may be mapped in a storage address space of the main storage device.

The input/output device 186 is composed of an I/O terminal for inputting signals from an external device, such as the display device 187, and outputting signals to the external device.

Note that the signal processing device 108 can be implemented not only by a single computer, but also by a plurality of computers connected to each other via the communication network NW to distribute processing. Further, the processor 182 may be implemented by hardware such as a Field-Programmable Gate Array (FPGA), a Large Scale Integration (LSI), or an Application Specific Integrated Circuit (ASIC).

### Operation of Distance Measurement Apparatus

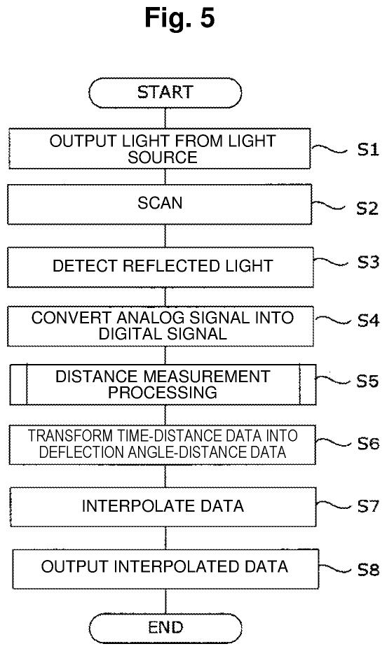

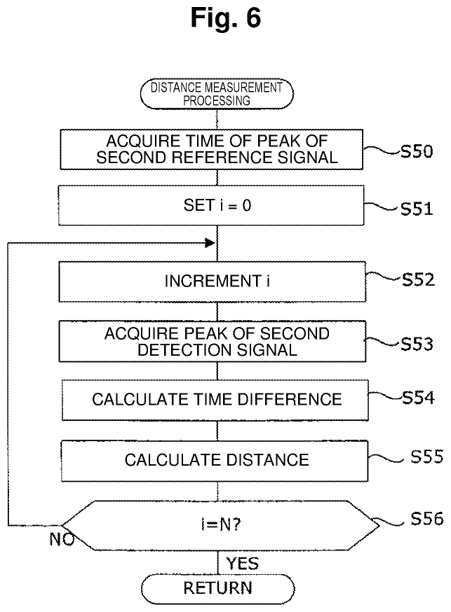

Next, an operation of the distance measurement apparatus 1 according to an embodiment will be described with reference to flowcharts of FIGS. 5 and 6.

First, the periodically intensity-modulated light, such as light that is intensity-modulated with a sine wave, is output from the light source 100 (step S1). The coupler 101 divides the light output from the light source 100 into light beams that pass through the reference optical path and the object optical path. The light beam passing through the reference optical path is received by the PDr 105 and is photoelectrically converted, and the first reference signal r1 is output. On the other hand, the light beam passing through the object optical path is deflected by the light deflector 103 through the circulator 102, and the object 104 and the area around the object are scanned with light (step S2).

Next, when the light deflected by the light deflector 103 scans the space once, the light is irradiated on the object 104 and reflected light is detected by the PDs 106 through the light deflector 103 and the circulator 102 (step S3). Further, the first angle signal θ1 representing the deflection angle at which the light is deflected by the light deflector 103 is input to the channel CH3 of the ADC 107.

After that, the ADC 107 converts an analog signal input to the channels CH1, CH2, and CH3 into a digital signal (step S4). More specifically, the first reference signal r1, which is an analog signal, is input to the channel CH1 of the ADC 107, and is converted into the digital second reference signal r2. The first detection signal s1, which is an analog signal, is input to the channel CH2 of the ADC 107 based on the reflected light from the object 104, and is converted into the digital second detection signal s2. Further, the first angle signal θ1 is input to the channel CH3 of the ADC 107 and is converted into the digital second angle signal θ2.

Next, in the signal processing device 108, the distance measurement unit 109 obtains the distance to the object 104 based on the time difference between the second reference signal r2 and the second detection signal s2 (step S5). More specifically, the distance measurement unit 109 clips a part of each of the second reference signal r2 and the second detection signal s2 by using the window functions wr(t) and ws(t) based on the time corresponding to the deflection angle set by the light deflector 103. The distance measurement unit 109 calculates the time difference between these two signals and obtains the difference based on the time difference.

Distance measurement processing to be performed by the distance measurement unit 109 will now be described with reference to the flowchart of FIG. 6.

First, the first acquisition unit 191 detects all peaks included in the second reference signal r2, and acquires the time corresponding to each of the peaks (step S50). The first acquisition unit 191 sets identification information i (i=0, 1, . . . , N) for distinguishing the plurality of peaks p_{r, i} included in the detected second reference signal r2, and initializes i (i=0) (step S51).

Next, the first acquisition unit 191 increments i (adds “1” to i) (step S52). After that, the second acquisition unit 192 acquires the peak p_{s, i} of the second detection signal s2 that is present in the time range of ±T_{source}/2 based on the time t_{r, i} of the i-th peak p_{r, i} of the second reference signal r2 (step S53).

Next, the time difference calculation unit 193 calculates the time difference Δtᵢ (=t_{s, i}−t_{r, i}) between the peak time t_{r, i} of the i-th peak p_{r, i} of the second reference signal r2 and the time t_{s, i} of the peak p_{s, i} of the detected second detection signal s2 (step S54).

More specifically, the time difference calculation unit 193 calculates the cross-correlation function R(t) in the above-described Expression (1), and the time when R(t) reaches the maximum value is set as the time difference Δtᵢ. Further, when the time difference calculation unit 193 clips signals in the vicinity of the peak time t_{r, i} and the peak time t_{s, i} of the second reference signal r2 and the second detection signal s2, the window functions wr(t) and ws(t), such as a Hamming window and a Blackman window, can be used.

The time difference calculation unit 193 can use the window function wr(t) which is designed to have a peak that matches the peak p_{r, i} of the second reference signal based on the peak time t_{r, i}. Further, the time difference calculation unit 193 can use the window function ws(t) which is designed to have a peak that matches the peak p_{s, i} of the second detection signal s2 based on the peak time t_{s, i}.

After that, the distance calculation unit 194 calculates the distance Lᵢ to the object 104 based on the time difference Δtᵢ calculated in step S54 (step S55). More specifically, the time-distance data Lᵢ at the time t_{r, i} of the i-th peak p_{r, i} of the second reference signal r2 is calculated by multiplying the light speed c by the time difference Δtᵢ and dividing the resultant by 2.

Next, before the distance calculation unit 194 calculates the distance to the object 104 at the time t_{r, i} of all peaks p_{r, i} included in the second reference signal r2 is calculated (step S56: NO), the distance measurement unit 109 repeats steps S52 to S55. On the other hand, when the distance calculation unit 194 calculates the distance to the object 104 at the time t_{r, i} of all peaks p_{r, i} included in the second reference signal r2 (i=N) (step S56: YES), the processing proceeds to step S6 in FIG. 5.

After that, as illustrated in FIG. 5, the time-angle transformation unit 110 transforms the time-distance data Lᵢ into deflection angle-distance data a by using the second angle signal θ2 indicating the deflection angle of the light deflector 103 (step S6). More specifically, the time-angle transformation unit 110 can use the intensity of the second angle signal θ2, the deflection angle, and the correspondence table, which are preliminarily stored in a predetermined area of the auxiliary storage device 185 and the main storage device 183. Alternatively, the time-angle transformation unit 110 reads out the function representing the relationship between the intensity and the deflection angle of the second angle signal θ2 stored in the auxiliary storage device 185 and the main storage device 183, and outputs the deflection angle-distance data a obtained by transforming time information into the deflection angle.

Next, the interpolation unit 111 interpolates data between peaks of the second reference signal r2 for the deflection angle-distance data a corresponding to the time-distance data Lᵢ for each peak time t_{r, i} of the second reference signal r2 (step S7). After that, the interpolated deflection angle-distance data b is output (step S8). For example, the interpolated deflection angle-distance data b can be displayed on the display device 187, or the interpolated deflection angle-distance data b can be transmitted to an external terminal device via the communication network NW.

As described above, the distance measurement apparatus 1 according to the present embodiment clips a part of two signals with a window function having a peak that matches the peak of the second reference signal r2 and a window function having a peak that matches the peak of the second detection signal s2. Further, the distance measurement apparatus 1 according to the present embodiment calculates the distance to the object 104 using the cross-correlation between these two signals. Therefore, the time difference between the two signals can be accurately calculated even when a window function is applied to the two signals, so that the distance to the object can be measured with high accuracy.

Further, the distance measurement apparatus 1 according to the present embodiment interpolates distance data between peaks of the reference signal, thereby making it possible to measure the distance to the object with high accuracy.

Embodiments of the distance measurement apparatus and the distance measurement method according to the present invention have been described above. However, the present invention is not limited to the above-described embodiments and can be modified in various ways that can be assumed by those skilled in the art within the scope of the invention described in the claims.

For example, the above-described embodiments illustrate a specific example where in the signal processing device 108, the time-angle transformation unit 110 transforms the time-distance data Lᵢ into the deflection angle-distance data a and then the interpolation unit 111 performs interpolation processing. However, the interpolation processing may be executed prior to the transformation processing to be performed by the time-angle transformation unit no. In this case, the interpolation unit 111 performs interpolation between peaks of the second reference signal r2 based on the time-distance data Lᵢ, and then the time-angle transformation unit 110 transforms a time into a deflection angle.

When the interpolation processing is performed prior to the time-angle transformation processing, each peak time of the second reference signal r2 acquired by the distance measurement unit 109 cannot be directly used as time information required for the time-angle transformation unit 110. This is because the number of distances obtained by the distance measurement unit 109 (that is equal to the number of peak times obtained by the first acquisition unit 191) is different from the number of distances output from the interpolation unit 111. Accordingly, the interpolation unit 111 calculates the time corresponding to the distance information obtained by interpolation using each peak time of the second reference signal r2 acquired by the distance measurement unit 109. Then, the time-angle transformation unit 110 transforms the time into an angle using the time.

Note that the interpolation unit 111 interpolates the second angle signal θ2 when the time interval between peaks of the interpolated second reference signal r2 does not match the time intervals between peaks of the second angle signal θ2 and thus the time in each piece of the interpolated time-distance data does not match the time in each piece of data on the second angle signal θ2. Thus, the second angle signal θ2 at the time corresponding to the angle that matches the time of the interpolated time-distance data is obtained, thereby obtaining the deflection angle at each time in the interpolated time-distance data.

The above-described embodiments illustrate a case where the light output from the light source 100 is periodically intensity-modulated light, such as a sine wave, and is not swept light. However, the light source 100 may be a swept light source including a periodic intensity modulation function. In this case, as the light deflector 103, a passive optical element, such as a transmission or reflection diffraction grating, or a prism made of a material having a large refractive index dispersion, is used. Further, the light source 100 may be a swept light source including a periodic intensity modulation function, or a known spatial light modulator may be used as the light deflector 103.

In this case, the lattice constant of a diffraction grating and the like can be designed to be deflected within a desired angle range depending on the wavelength of light from the light source 100, a maximum distance required to be measured, the size of the distance measurement apparatus 1, or the like. As for a refractive index of a prism and the wavelength dispersion of the refractive index, materials having the refractive index and the wavelength dispersion can be selected so that light is deflected at a desired angle. Further, in the case of using the swept light source including the periodic intensity modulation function as the light source 100, the first angle signal θ1 is configured to work with the wavelength of light output from the light source 100.

The swept light source including the periodic intensity modulation is used as the light source 100, and the passive optical element, such as a diffraction grating or a prism, is used as the light deflector 103. This is advantageous in eliminating the need for the light deflector 103 to be provided with components that require a mechanical operation. Therefore, for example, in a case where the optical system included in the distance measurement apparatus 1 is divided into the light deflector 103 and the other portions, the deflector is used as a probe and the other portions are used as a main body, and the probe and the main body are connected with an optical fiber, the probe can be downsized. This enables the measurement by, for example, installing the probe portion in a narrow space or the like, or by easily carrying the probe portion by a person. Furthermore, since the probe is provided with no components that require a mechanical operation, the probe has a high resistance to vibration. Therefore, the main body and the probe are separated from each other and the main body is caused to retract to a location where vibrations are small, thereby making it possible to accurately perform the measurement even under an environment in which large vibrations are generated.

### REFERENCE SIGNS LIST

1 Distance measurement apparatus
100 Light source
101 Coupler
102 Circulator
103 Light deflector
104 Object
105 Photodetector PDr
106 Photodetector PDs
107 ADC
108 Signal processing device
109 Distance measurement unit
110 Time-angle transformation unit
111 Interpolation unit
181 Bus
182 Processor
183 Main storage device
184 Communication interface
185 Auxiliary storage device
186 Input/output device
187 Display device
191 First acquisition unit
192 Second acquisition unit
193 Time difference calculation unit
194 Distance calculation unit

1.-8. (canceled)

9. A distance measurement apparatus comprising:
a first acquisition unit that detects a first peak as a peak included in a first signal obtained by photoelectrically converting light periodically intensity-modulated and output from a light source, and acquires a time of each first peak;
a second acquisition unit that acquires, from a second signal, a second peak as a peak present in a time range of one cycle of intensity modulation of light from the light source based on the time of the first peak, the second peak being obtained by photoelectrically converting reflected light, the reflected light being the light output from the light source and reflected by an object to be measured; and
a distance calculation unit that calculates a distance to the object based on a cross-correlation between a third signal and a fourth signal, the third signal being obtained by processing the first signal with a first window function in a state where a peak of the first window function having the peak matches the first peak, the fourth signal being obtained by processing the second signal with a second window function in a state where a peak of the second window function having the peak matches the second peak.

10. The distance measurement apparatus according to claim 9, further comprising an optical system including:
an optical splitter that splits light from the light source into two beams;
a first photodetector that detects one of the beams of the light output from the optical splitter;
a light deflector that deflects the other of the beams of the light output from the optical splitter and outputs the deflected beam to the object; and
a second photodetector that detects reflected light, the reflected light being light output from the light deflector and reflected by the object,
wherein the first photodetector outputs the first signal obtained by photoelectrically converting the detected light, and
wherein the second photodetector outputs the second signal obtained by photoelectrically converting the detected reflected light.

11. The distance measurement apparatus according to claim 10, further comprising a time-angle transformation unit that transforms time information corresponding to the time of the first peak calculated by the distance calculation unit into information about a deflection angle set by the light deflector, and outputs a deflection angle-distance signal indicating the deflection angle associated with the distance.

12. The distance measurement apparatus according to claim 9, further comprising an interpolation unit that interpolates the distance to the object corresponding to the time of each first peak of the first signal calculated by the distance calculation unit.

13. The distance measurement apparatus according to claim 9,
wherein the distance calculation unit includes a time difference calculation unit that calculates, using the cross-correlation, a time difference indicating a time delay of the second signal with respect to the first signal at the time of the first peak, and
wherein the distance calculation unit calculates the distance to the object corresponding to the time of each first peak of the first signal based on the calculated time difference.

14. The distance measurement apparatus according to claim 9, wherein the first window function and the second window function have the same shape.

15. The distance measurement apparatus according to claim 9, wherein the first window function and the second window function are any one of a Gaussian window, a Hann window, a Hamming window, a Blackman window, and a generalized Hamming window.

16. A distance measurement method comprising:
a first step of detecting a first peak as a peak included in a first signal obtained by photoelectrically converting light periodically intensity-modulated and output from a light source, and acquires a time of each first peak;
a second step of acquiring, from a second signal, a second peak as a peak present in a time range of one cycle of intensity modulation of light from the light source based on the time of the first peak, the second peak being obtained by photoelectrically converting reflected light, the reflected light being the light output from the light source and reflected by an object to be measured; and
a third step of calculating a distance to the object based on a cross-correlation between a third signal and a fourth signal, the third signal being obtained by processing the first signal with a first window function in a state where a peak of the first window function having the peak matches the first peak, the fourth signal being obtained by processing the second signal with a second window function in a state where a peak of the second window function having the peak matches the second peak.
